(19) United States
(12) Patent Application Publication
(10) Pub. No.: US 2022/0358402 A1
(43) Pub. Date: Nov. 10, 2022

(54) SYSTEMS AND METHODS OF PREDICTING MICROAPP ENGAGEMENT

(71) Applicant: Citrix Systems, Inc., Ft. Lauderdale, FL (US)

(72) Inventors: Abirami Sukumaran, Ft. Lauderdale, FL (US); Aikaterini Kalou, Patras (GR); Dimitrios Markonis, Athens (GR); Konstantinos Katrinis, Athens (GR); Marcin Simon, Ft. Lauderdale, FL (US)

(73) Assignee: Citrix Systems, Inc., Ft. Lauderdale, FL (US)

(21) Appl. No.: 17/340,565

(22) Filed: Jun. 7, 2021

Related U.S. Application Data
(63) Continuation of application No. PCT/GR2021/000028, filed on May 6, 2021.

(51) Int. Cl. G06N 20/00; G06N 5/02

(52) U.S. Cl. CPC G06N 20/00; G06N 5/02

(57) ABSTRACT

A computer system including a memory, a network interface, and a processor is provided. The processor is configured to receive, via the network interface, one or more design attributes of a microapp from a microapp development tool hosted by an endpoint device, the one or more design attributes comprising an identifier of a system of record configured to supply data to the microapp; execute a machine learning process trained, using data regarding microapp usage within an organization, to predict at least one user engagement metric for the microapp based on the one or more design attributes; and transmit, via the network interface, the at least one user engagement metric to the microapp development tool hosted by the endpoint device.

### RELATED APPLICATIONS

This application claims priority under 35 U.S.C. § 120 as a continuation of PCT Application No. PCT/GR2021/000028, titled “SYSTEMS AND METHODS OF PREDICTING MICROAPP ENGAGEMENT,” filed May 6, 2021. PCT Application No. PCT/GR2021/000028 is hereby incorporated herein by reference in its entirety.

### BACKGROUND

A microapp is a lightweight software application that interoperates with one or more source applications to provide a user with access to specific, targeted functionality implemented, at least in part, by the source applications. Microapps provide access to this functionality in a streamlined manner via a relatively simple, contained interface. Generally, a user can access the functionality provided by a microapp without needing to launch a new application or toggle to a different application window. Microapps thus allow users to complete simple tasks within the context of an existing application environment, such as a web browser, a digital workspace, or other similar context. Microapps are often referred to as “cross-platform” software applications because they typically execute within the context of a native application that serves as a container that isolates the microapp from idiosyncrasies of different operating system platforms.

### SUMMARY

In at least one example, a computer system is provided. The computer system includes a memory, a network interface, and at least one processor coupled to the memory and the network interface. The at least one processor is configured to receive, via the network interface, one or more design attributes of a microapp from a microapp development tool hosted by an endpoint device, the one or more design attributes comprising an identifier of a system of record configured to supply data to the microapp; execute a machine learning process trained, using data regarding microapp usage within an organization, to predict at least one user engagement metric for the microapp based on the one or more design attributes; and transmit, via the network interface, the at least one user engagement metric to the microapp development tool hosted by the endpoint device.

Some examples of the computer system can include one or more of the following features. The at least one processor can be further configured to identify the machine learning process from a plurality of machine learning processes. The plurality of machine learning processes can include a first machine learning process trained using data regarding microapp usage within the organization and a second machine learning process trained using data regarding microapp usage within the organization. The organization can be a first organization and the plurality of machine learning processes can include a first machine learning process trained using data regarding microapp usage within the first organization and a second machine learning process trained using data regarding microapp usage within a second organization distinct from the first organization. The microapp can be designed for use within the second organization.

In the computer system, to identify the machine learning process can include to match the second organization with the first organization. To match can include to calculate a distance between vector representations of the second organization and the first organization. In the computer system, the machine learning process can be a first machine learning process and the at least one processor can be further configured to train a second machine learning process using data regarding microapp usage in the second organization and execute the second machine learning process to predict one or more user engagement metrics for the microapp based on the one or more design attributes.

In at least one example, a method of predicting user engagement metrics based on a microapp design is provided. The method includes receiving, via a network interface, one or more design attributes of a microapp from a microapp development tool hosted by an endpoint device, the one or more design attributes comprising an identifier of a system of record configured to supply data to the microapp; executing a machine learning process trained, using data regarding microapp usage within an organization, to predict at least one user engagement metric for the microapp based on the one or more design attributes; and transmitting, via the network interface, the at least one user engagement metric to the microapp development tool hosted by the endpoint device.

Some examples of the method can include one or more of the following features. The method can further include identifying the machine learning process from a plurality of machine learning processes. Identifying the machine learning process from a plurality of machine learning processes can include identifying the machine learning process from a first machine learning process trained using data regarding microapp usage within the organization and a second machine learning process trained using data regarding microapp usage within the organization. The organization can be a first organization and identifying the machine learning process from a plurality of machine learning processes can include identifying the machine learning process from a first machine learning process trained using data regarding microapp usage within the first organization and a second machine learning process trained using data regarding microapp usage within a second organization distinct from the first organization.

In the method, receiving the one or more design attributes of the microapp can include receiving one or more design attributes of a microapp designed for use within the second organization. Identifying the machine learning process can include matching the second organization with the first organization. Matching can include calculating a distance between vector representations of the second organization and the first organization.

In the method, the machine learning process can be a first machine learning process, and the method can further include training a second machine learning process using data regarding microapp usage in the second organization and executing the second machine learning process to predict one or more user engagement metrics for the microapp based on the one or more design attributes.

In at least one example, a non-transitory computer readable medium is provided. The computer readable medium stores processor executable instructions to predict user engagement metrics based on a microapp design. The instructions include instructions to receive, via a network interface, one or more design attributes of a microapp from a microapp development tool hosted by an endpoint device, the one or more design attributes comprising an identifier of a system of record configured to supply data to the microapp; execute a machine learning process trained, using data regarding microapp usage within an organization, to predict at least one user engagement metric for the microapp based on the one or more design attributes; and transmit, via the network interface, the at least one user engagement metric to the microapp development tool hosted by the endpoint device.

Some examples of the computer readable medium can include one or more of the following features. The instructions further include instructions to identify the machine learning process from a plurality of machine learning processes. In the computer readable medium, the organization can be a first organization and the instructions to identify the machine learning process can include instructions to match a second organization with the first organization. The machine learning process can be a first machine learning process and the instructions can further include instructions to train a second machine learning process using data regarding microapp usage in the second organization and execute the second machine learning process to predict one or more user engagement metrics for the microapp based on the one or more design attributes.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram depicting a user engagement prediction system in accordance with an example of the present disclosure.

FIGS. 2A and 2B are front views of user interface screens configured to receive microapp design attributes and display a prediction of user engagement in accordance with an example of the present disclosure.

FIGS. 3A and 3B are front views of user interface screens configured to display user engagement metrics in accordance with an example of the present disclosure.

FIGS. 4A and 4B are a flow diagram showing a process for registering a machine learning model to predict user engagement in accordance with an example of the present disclosure.

FIG. 5 is a flow diagram of illustrating a prediction process in accordance with an example of the present disclosure.

FIG. 6 is a block diagram of a network environment of computing devices in which various aspects of the present disclosure can be implemented.

FIG. 7 is a block diagram of the user engagement prediction system illustrated in FIG. 1 as implemented by a configuration of computing devices in accordance with an example of the present disclosure.

### DETAILED DESCRIPTION

As summarized above, some examples described herein are directed to systems and methods that predict user engagement with microapps. Such a predictive feature is missing from other microapp development tool sets. As such, the systems and methods described herein improve upon existing technology by providing microapp developers with insight not available within other tool sets.

For instance, in at least some examples, the systems and methods described herein predict user engagement with microapps early in the development cycle (e.g., during the design phase). In so doing, the systems and methods identify designs that are likely to be underutilized by a user community. Such designs can be removed from a group of designs under consideration for implementation or modified to increase their relevance to users prior to being placed into production. This aspect of the systems and methods described herein conserves system resources. Microapps that are placed in production but underutilized burden the system unduly because the resources consumed by these microapps are not sufficiently offset by their value proposition to the organization.

By analyzing designs of microapps prior to devoting substantial programming effort to any given one, the predictive systems and methods disclosed herein also help developers avoid effort wasted on designs that are less likely to be adopted by users. Moreover, early prediction of microapp designs that are likely to be favored by users helps developers and users avoid multiple trial and error iterations of a given microapp. Protracted iterative development can result in reduced user adoption and engagement, as users tire of, and develop an aversion to, microapps that repeatedly fail to meet their expectations.

In certain examples, the systems and methods described herein can also be applied to improve underperforming microapps that are already in production. In these examples, the systems and methods described herein can predict how potential design changes in the production microapps may affect user engagement, without requiring actual implementation of the changes or testing by users. Thus, in these examples, the systems and methods described can conserve system resources by improving underperforming microapps and avoid protracted iterative efforts to improve such microapps.

The predictive systems and methods described herein address the disadvantages described above, as well as other issues, and are described further below. Examples of the systems and methods discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### User Engagement Prediction System

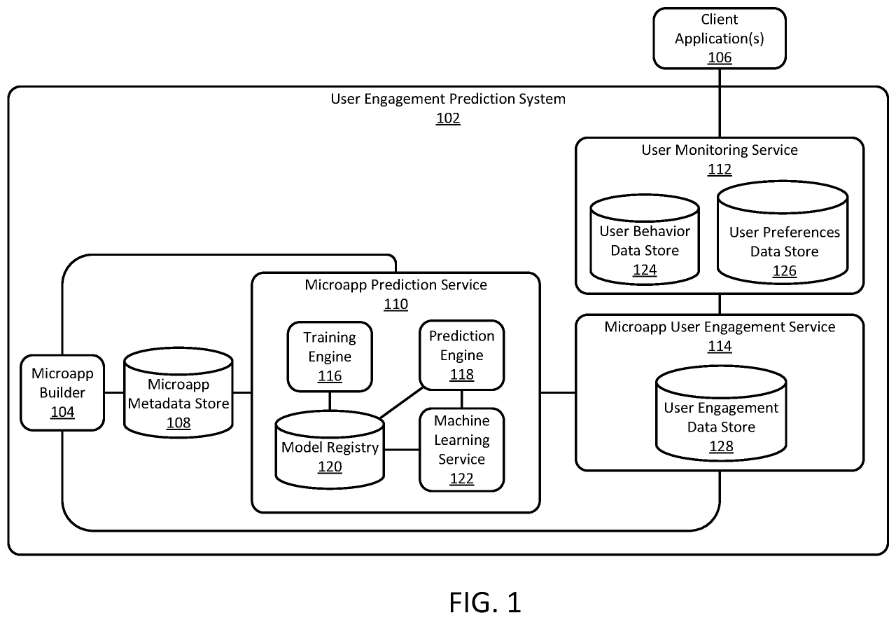

In some examples, a computer system is configured to predict future user engagement with a microapp based on design attributes thereof. FIG. 1 illustrates a logical architecture of a user engagement prediction system 102 in accordance with these examples.

As shown in FIG. 1, the system 102 includes a microapp builder 103, a microapp metadata store 108, a microapp prediction service 110, a user monitoring service 112, and a microapp user engagement service 114. The prediction service 110 includes a training engine 116, a prediction engine 118, a model registry 120, and a machine learning service 122. The monitoring service 112 includes a user behavior data store 124 and a user preferences data store 126. The engagement service 114 includes a user engagement data store 128. FIG. 1 also illustrates lines of communication between these computer-implemented processes and data stores. Details regarding these communications are provided below, but it should be noted that the depicted lines of communication can include inter-process communication (e.g., where two or more of the computer-implemented processes and/or data stores illustrated in FIG. 1 reside within the same execution environment) and network-based communication (e.g., where two or more of the computer-implemented processes and/or data stores reside in different execution environments coupled to one another by a computer network). In some examples, the lines of communication can include hypertext transfer protocol (HTTP) based communications. The computer-implemented processes illustrated in FIG. 1 can be implemented in hardware or a combination of hardware and software.

Continuing with the system 102, the microapp builder 104 is a computer-implemented process that is configured to interact with a user to design and develop microapps. In some examples, the microapp builder 104 is configured to provide the user with a graphically-oriented development environment that requires little or no actual coding to develop microapp designs and implement the same. In at least one example, the microapp builder 104 includes a Citrix Microapp Builder which is commercially available from Citrix Systems, Inc. of Ft. Lauderdale, Florida. However, in these examples, the microapp builder 104 is further configured to provide user engagement functionality not available in other microapp builders. This user engagement functionality may include display of actual user engagement metrics derived from usage of production microapps and predicted user engagement metrics generated by the system 102.

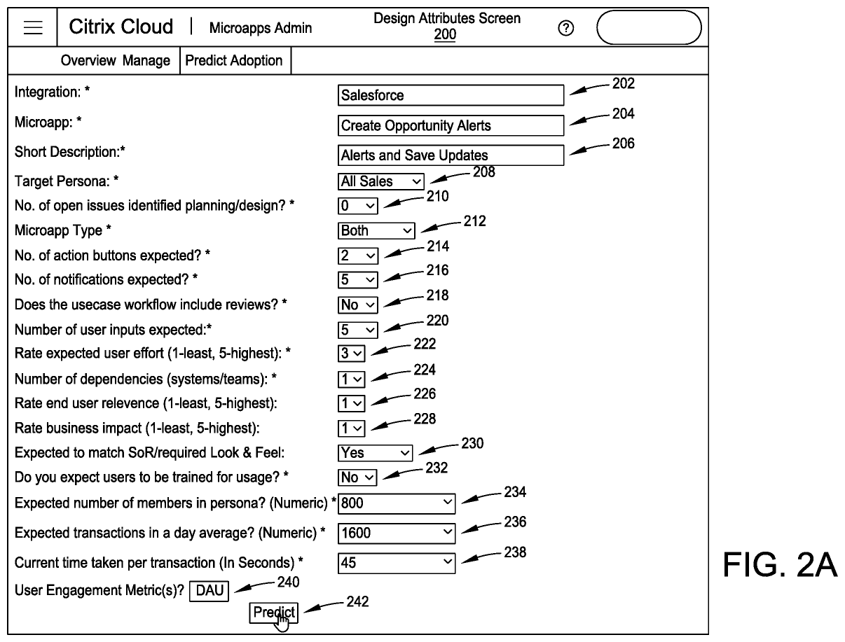

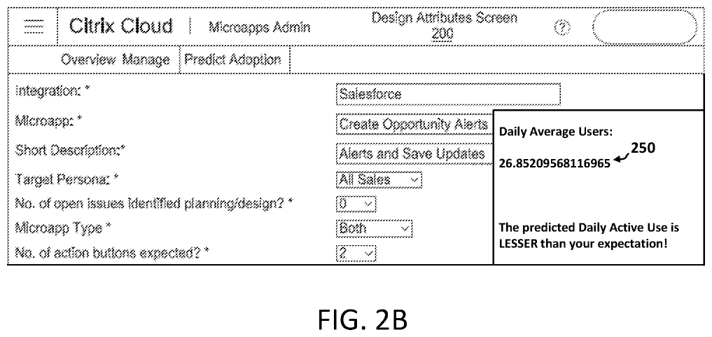

For instance, in some examples, the microapp builder 104 is configured to interact with the user to receive input specifying one or more design attributes of a microapp subject to engagement analysis. The subject microapp may be a microapp being considered for development, a fully developed microapp that is already in production and being used by a user community, or a microapp somewhere between these stages of development. An example of a user interface screen that the microapp builder 104 is configured to render to support this user interaction is illustrated in FIG. 2A.

As shown in FIG. 2A, a design attribute screen 200 includes controls 202-238 that each are configured to receive input specifying an attribute of a microapp design. The controls illustrated in FIG. 2 include an integration control 202, a microapp control 204, a description control 206, a persona control 208, an issues control 210, a microapp type control 212, a buttons control 214, a notifications control 216, a reviews control 218, an inputs control 220, an effort control 222, a dependencies control 224, a relevance control 226, an impact control 228, a match control 230, a training control 232, a members control 234, a transactions control 236, and a time control 238. As illustrated in FIG. 2A, the screen 200 also includes metrics control 240 and a predict control 242.

In some examples, the integration control 202 is configured to receive input specifying a system of record (SoR) with which a microapp is designed to interoperate. Examples of such SoRs can include any application that is the authoritative source of data to be manipulated by the subject microapp. Examples of a SoR include commercially available enterprise applications (e.g., SAP® enterprise management software, Salesforce customer relationship management software, PeopleSoft® human resource management software, and other potentially proprietary software, to name a few examples. In the example of FIG. 2A, the integration control 202 has received input specifying that Salesforce is the SoR with which the subject microapp is designed to interoperate.

In certain examples, the microapp control 204 is configured to receive input specifying a title or name of a microapp. In the example of FIG. 2A, the microapp control 204 has received input specifying that “Create Opportunity Alerts” is the title of the subject microapp.

In some examples, the description control 206 is configured to receive input specifying a short description of a microapp. In the example of FIG. 2A, the description control 206 has received input specifying that “Alerts and Save Updates” is the short description of the subject microapp.

In certain examples, the persona control 208 is configured to receive input specifying a group of users targeted by a microapp. In the example of FIG. 2A, the persona control 208 has received input specifying that all salespeople within the organization are targeted by the subject microapp.

In some examples, the issues control 210 is configured to receive input specifying a number of open issues identified with a design of a microapp. In the example of FIG. 2A, the issues control 210 has received input specifying that number of open issues with the design of the subject microapp is 0.

In certain examples, the type control 212 is configured to receive input specifying a microapp type. For instance, the input may specify a microapp is one or more of event-driven or user-initiated. In the example of FIG. 2A, the type control 212 has received input specifying that the subject microapp is both event-driven and user-initiated.

In some examples, the buttons control 214 is configured to receive input specifying a number of buttons used in a design of a microapp. In the example of FIG. 2A, the buttons control 214 has received input specifying that number of buttons used within the design of the subject microapp is 2.

In certain examples, the notifications control 216 is configured to receive input specifying a number of notifications to be issued according to a design of a microapp. In the example of FIG. 2A, the notifications control 216 has received input specifying that number of notifications to be issued by the subject microapp is 5.

In some examples, the reviews control 218 is configured to receive input specifying whether a design of a microapp requires reviews by more than 1 user. In the example of FIG. 2A, the reviews control 218 has received input specifying that the design of the subject microapp includes no reviews by personnel other than the user.

In certain examples, the inputs control 220 is configured to receive input specifying a number of inputs expected from users during execution of a single instance of a microapp. In the example of FIG. 2A, the inputs control 220 has received input specifying that number of inputs expected by the subject microapp is 5.

In some examples, the effort control 222 is configured to receive input specifying a level of user effort required to successfully use a microapp. This level of effort may be expressed as a number from 1 to 5 with 1 being the level of least effort and 5 being the level of greatest effort. In the example of FIG. 2A, the effort control 222 has received input specifying that the level of effort of the subject microapp is 3.

In certain examples, the dependencies control 224 is configured to receive input specifying a number of dependencies within a workflow of a microapp design. These dependencies can originate, for example, from automated systems or teams involved in the workflow. In the example of FIG. 2A, the dependencies control 224 has received input specifying that number of dependencies involved with the subject microapp is 1.

In some examples, the relevance control 226 is configured to receive input specifying a level of relevance of a microapp to a user belonging to a group of users specified by the persona control 208. This level of relevance may be expressed as a number from 1 to 5 with 1 being the level of least relevance and 5 being the level of greatest relevance. In the example of FIG. 2A, the relevance control 226 has received input specifying that the level of relevance of the subject microapp is 1.

In certain examples, the impact control 228 is configured to receive input specifying a level of impact of a microapp to a user's business. This level of business impact may be expressed as a number from 1 to 5 with 1 being the level of least impact and 5 being the level of greatest impact. In the example of FIG. 2A, the impact control 228 has received input specifying that the level of business impact of the subject microapp is 1.

In some examples, the match control 230 is configured to receive input specifying whether a design of a microapp is expected to match the look and feel of an SoR with which the microapp is designed to interoperate. In the example of FIG. 2A, the match control 230 has received input specifying that the subject microapp is expected to match the look and feel of the SoR specified in integration control 202.

In certain examples, the training control 232 is configured to receive input specifying whether users are expected to train on a microapp. In the example of FIG. 2A, the training control 232 has received input specifying that users are not expected to train on the subject microapp.

In some examples, the member control 234 is configured to receive input specifying a number users within an organization who belong to a group specified by the persona control 208. In the example of FIG. 2A, the member control 234 has received input specifying that number of users who belong to the group specified by the persona control 208 for the subject microapp to be 800.

In certain examples, the transactions control 236 is configured to receive input specifying a number of transactions a microapp is expected to handle daily. In the example of FIG. 2A, the transactions control 236 has received input specifying that the number of transactions that the subject microapp is expected to handle daily is 1600.

In some examples, the time control 238 is configured to receive input specifying a number seconds of user time that each transaction of with microapp is expected to consume. In the example of FIG. 2A, the time control 238 has received input specifying that number of seconds of user time that each transaction with the subject microapp is expected to consume is 45.

It should be noted that the controls illustrated in the screen 200 and the design attributes specified thereby are provided by way of example only. As such, some implementations of the screen 200 may include fewer or more controls than those shown in FIG. 2A. For instance, in at least one example, the screen 200 includes an efficiency control configured to receive input specifying whether the subject microapp is designed to be more time efficient for the user in completing a workflow than the SoR with which the microapp interoperates. This input may be stored as, for example, a Boolean value indicating that the subject microapp either is or is not designed to be more efficient than the SoR, or may be stored as a numerical value indicating a level of efficiency of the microapp as compared to the SoR. In some examples, the screen 200 is configurable by the user to include other controls addressing other design attributes.

In some examples, the design attributes specified by the input received via the screen 200 are stored in the metadata store 108 for subsequent processing.

Continuing with the screen 200, the metrics control 240 is configured to receive input specifying one or more user engagement metric(s) to predict for a microapp. Examples of user engagement metrics that can be specified via the metrics control 240 include daily average users (DAU), monthly active users (MAU), stickiness ratio (DAU/MAU), daily sessions per DAU, average session length, average session frequency, retention rate, and churn rate, to name a few. In the example of FIG. 2A, the metrics control 240 has received input specifying that DAU is to be predicted for the subject microapp.

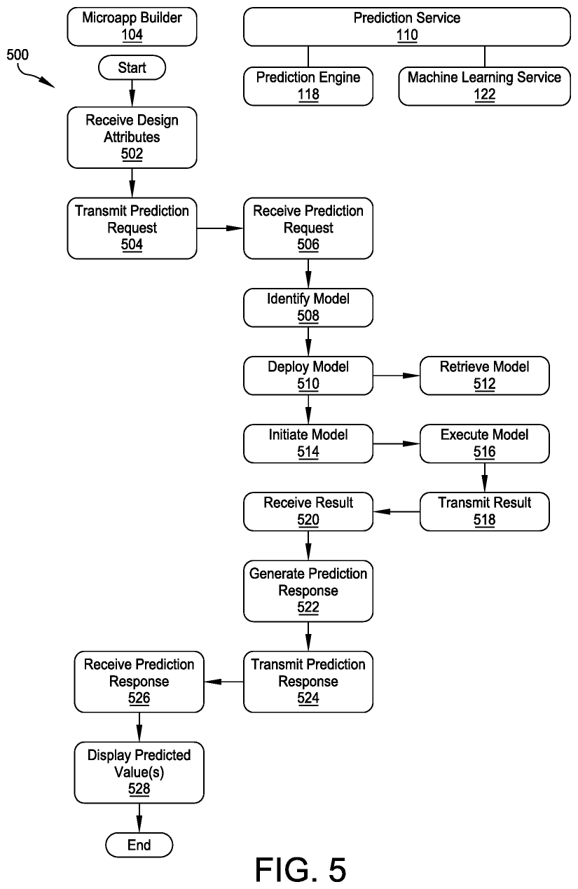

Continuing with the screen 200, the predict control 242 is configured to receive a message indicating its selection via user input and, in response thereto, to transmit a prediction request to a prediction service (e.g., the prediction service 110 of FIG. 1). For instance, in one example, the predict control 242 transmits a hypertext transport protocol (HTTP) POST request to a universal resource identifier (URI) corresponding to a representational state transfer (REST) application programming interface (API) endpoint exposed by the prediction service for the user's organization. The prediction request specifies an identifier of the user's organization and includes a copy (e.g., in a JavaScript Object Notation (JSON) object) of the design attributes specified in the screen 200. The prediction service is configured to receive and parse the prediction request to extract the identifier of the user's organization and the design attributes and execute a trained machine learning process associated with the organization identifier using the extracted design attributes to generate one or more predicted value(s) of the user engagement metric(s). The prediction service is further configured to generate a response to the prediction request that specifies the predicted value(s) of the user engagement metric(s) and transmit the response to the microapp builder 104. Examples of processes executed by the prediction service when executing according to this configuration are described further below with reference to FIG. 5. The microapp builder is configured to receive and parse the response to extract the predicted value(s) of user engagement metric(s) and to display the extracted predicted value(s) via the screen 200, as illustrated in FIG. 2B.

In some examples, the predict control 242 is configured to transmit (instead of, or in addition to, the prediction request) a priority request to a user engagement service (e.g., the user engagement service 114 of FIG. 1). This priority request may include, for example, the identifier of a SoR specified in the integration control 202. In these examples, the user engagement service is configured to maintain a ranking based on user engagement of SoRs in production within the user's organization. This ranking may be based on, for example, DAU. Further, in these examples, the user engagement service is configured to reply to the priority request with a response that specifies the ranking of the SoR identified in the priority request. In these examples, the microapp builder is configured to receive the priority response and display the ranking as a priority score via a control of the screen 200 instead of, or in addition to, the predicted value as detailed below with reference to FIG. 2B. It should be noted that, in some examples, the SoRs used to determine the ranking are restricted to SaaS SoRs.

As shown in FIG. 2B, the screen 200 further includes a DAU control 250 that is configured to display a predicted value for DAU. In the example illustrated in FIG. 2B the predicted value of DAU is 26.85209568116965. Further, as shown in FIG. 2B, the DAU control 250 is also configured to compare the predicted value to a previous specified target value for DAU and to display a message comparing the predicted value to the target value. Here the message indicates that the predicted DAU is less than the target value.

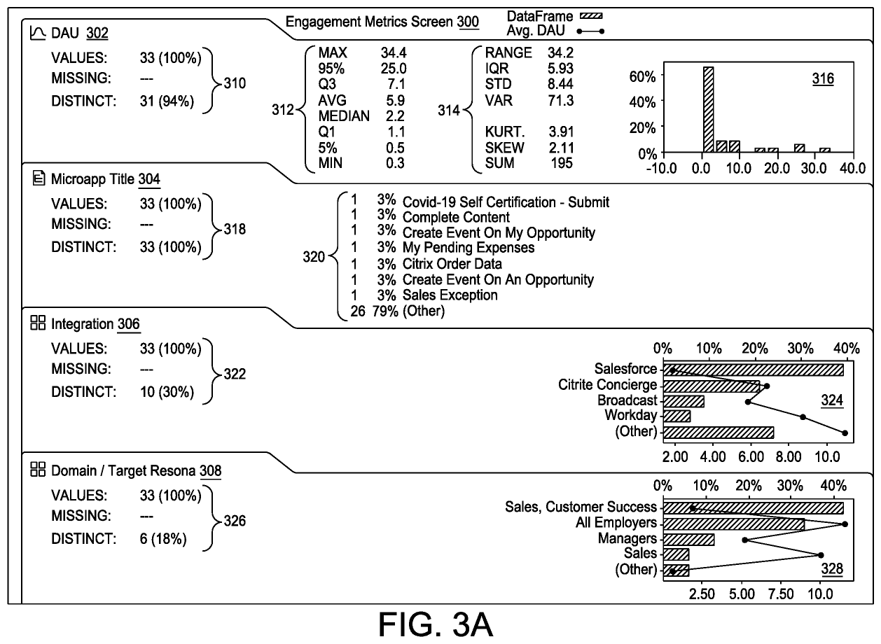

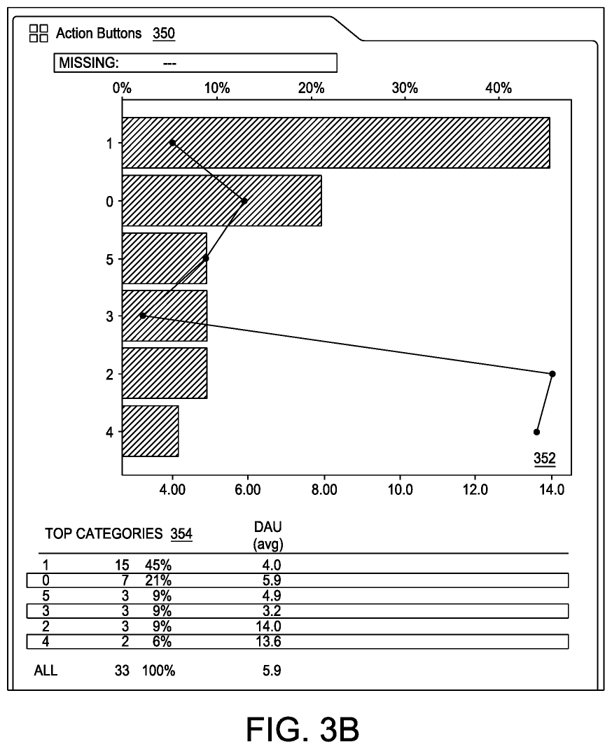

Returning to the system 102 of FIG. 1, in some examples, the microapp builder 104 is configured to interact with the user to provide the user with insights regarding user engagement with production microapps. In these examples, the microapp builder 104 is configured to interoperate with the engagement service 114 (e.g., via an API exposed and implemented by the engagement service 114) to access a variety of user engagement metrics stored in the data store 128 and to display these metrics to the user via one or more user interface controls. These engagement metrics can be derived from transactional data descriptive of interactions between production microapps and users. Examples of user interface screens that the microapp builder 104 is configured to render to support this user interaction are illustrated in FIGS. 3A and 3B.

It should be noted that the transactional data used to calculate the engagement metrics can be sourced from the user monitoring service 112, which is described further below. The transaction data can include, for example, a record for each interaction between a user and a microapp. Each record can include fields with values that specify one or more of the following elements: a timestamp marking the beginning of the interaction, a timestamp marking the end of the interaction, an identifier of the interaction, an identifier of the user involved in the interaction, an identifier of a persona to which the user belonged during the interaction, an identifier of a microapp involved in the interaction, a title of the microapp during the interaction, an SoR integrated with the microapp and invoked during the interaction, an indication of an outcome of the interaction (e.g., completion or early termination), and a number of buttons rendered by the microapp during the interaction. Other data elements may be specified within transactional data and, as such, the foregoing list should not be considered to be limiting.

As shown in FIG. 3A, a user engagement metrics screen 300 includes a DAU control 302, a title control 304, an integration control 306, and a persona control 308. Within the screen 300, each of the controls 302-308 is a tab control and, collectively, the controls 302-308 constitute a dashboard of user engagement information. The DAU control 302 includes statistical control sets 310, 312, and 314 and a graph control 316. The title control 304 includes statistical control set 318 and table control 320. The integration control 306 includes statistical control set 322 and graph control 324. The persona control 308 includes statistical control set 326 and graph control 328.

With regard to the DAU control 302, each control within the statistical control sets 310, 312, and 314 is configured to display a summary statistic of a set of DAU values calculated from transactional data records falling within a target period (e.g., a day, a week, a month, a year, etc.). As shown in FIG. 3A, the statistical control set 310 includes a VALUES control configured to display a count of the transactional data records used to calculate the set of DAU values. The statistical control set 310 also includes a MISSING control configured to display a count of the transactional data records not used to calculate the set of DAU values. The statistical control set 310 further includes a DISTINCT control configured to display the count of unique DAU values within the set of DAU values. In the example illustrated in FIG. 3A, the VALUES control displays a value of 33, which is 100% of the transactional data records; the MISSING control displays a null value, which is 0% of the transactional data records; and the DISTINCT control displays a value of 31, which is 94% of the set of DAU values.

As shown in FIG. 3A, the statistical control set 312 includes a MAX control configured to display the maximum DAU value from the set of DAU values, a 95% control configured to display a DAU value residing at the 95th percentile of the set of DAU values (when placed in ascending order), and a Q3 control configured to display a DAU value residing at the third quartile of the set of DAU values (when placed in ascending order). The statistical control set 312 further includes an AVG control configured to display an average value of the set of DAU values, a MEDIAN control configured to display a median value of the set of DAU values, and a Q1 control configured to display a DAU value residing at the first quartile of the set of DAU values (when placed in ascending order). The statistical control set 312 further includes a 5% control configured to display a DAU value residing at the 5^{th} percentile of the set of DAU values (when placed in ascending order) and a MIN control configured to display the maximum DAU value from the set of DAU values. In the example illustrated in FIG. 3A, the MAX control displays a value of 34.4, the 95% control displays a value of 25.0, the Q3 control displays a value of 7.1, the AVG control displays a value of 5.9, the MEDIAN control displays a value of 2.2, the Q1 control displays a value of 1.1, the 5% control displays a value of 0.5, and the MIN control displays a value of 0.3.

As shown in FIG. 3A, the statistical control set 314 includes a RANGE control configured to display a range of the set of DAU values, an IQR control configured to display an interquartile range of the set of DAU values (when placed in ascending order), and an STD control configured to display a standard deviation of the set of DAU values. The statistical control set 314 further includes an VAR control configured to display a variance of the set of DAU values, a KURT control configured to display a kurtosis of the set of DAU values, and a SKEW control configured to display a skewness of the set of DAU values. The statistical control set 314 further includes a SUM control configured to display a sum of the set of DAU values. In the example illustrated in FIG. 3A, the RANGE control displays a value of 34.2, the IQR control displays a value of 5.93, the STD control displays a value of 8.44, the VAR control displays a value of 71.3, the KURT control displays a value of 3.91, the SKEW control displays a value of 2.11, and the SUM control displays a value of 195.

Continuing with the DAU control 302, the graph control 316 displays a histogram of the set of DAU values. In the example illustrated in FIG. 3A, the histogram indicates that approximately 66% of the set of DAU values are between 0.0 and 3.3, that approximately 9% of the set of DAU values are between 3.3 and 6.6, and that approximately 9% of the set of DAU values are between 6.6 and 9.9. The histogram further indicates that approximately 3% of the set of DAU values are between 13.3 and 16.6, that approximately 3% of the set of DAU values are between 16.6 and 19.9, and that approximately 6% of the set of DAU values are between 23.3 and 26.6. The histogram further indicates that approximately 3% of the set of DAU values are between 31.0 and 34.4.

With regard to the title control 304, each control within the statistical control set 318 is configured to display a summary statistic of a set of titles of microapps identified in the transactional data records falling within the target period. As shown in FIG. 3A, the statistical control set 318 includes a VALUES control configured to display a count of the transactional data records used to identify titles within the set of titles. The statistical control set 318 also includes a MISSING control configured to display a count of the transactional data records not used to identify titles within the set of titles. The statistical control set 318 further includes a DISTINCT control configured to display a count of unique titles with the set of titles. In the example illustrated in FIG. 3A, the VALUES control displays a value of 33, which is 100% of the transactional data records; the MISSING control displays a null value, which 0% of the transactional data records; and the DISTINCT control displays a value of 33, which is 100% of the set of titles.

Continuing with the title control 304, the table control 320 displays a ranking of counts of titles from the set of titles. The information listed in the table control 320 includes a count for each title that is equal to a number of times that the title appears in the set of titles, a percentage of the cardinality of the set of titles represented by each count, and a title counted. In the example illustrated in FIG. 3A, the each of 33 microapps was executed one time. As such, each count is one, or 3% of the cardinality of the set of titles, and each count is associated with a single title.

With regard to the integration control 306, each control within the statistical control set 322 is configured to display a summary statistic of a set of SoRs identified in the transactional data from the target period. As shown in FIG. 3A, the statistical control set 322 includes a VALUES control configured to display a count of the transactional data records used to identify SoRs within the set of SoRs. The statistical control set 322 also includes a MISSING control configured to display a count of the transactional data records not used to identify SoRs within the set of SoRs. The statistical control set 322 further includes a DISTINCT control configured to display a number of unique SoRs identified within the set of SoRs. In the example illustrated in FIG. 3A, the VALUES control displays a value of 33, which is 100% of the transactional data records; the MISSING control displays a null value, which 0% of the transactional data records; and the DISTINCT control displays a value of 10, which is 30% of the set of SoRs.

Continuing with the integration control 306, the graph control 324 displays a histogram of the set of SoRs. In the example illustrated in FIG. 3A, this histogram indicates that approximately 39% of the set of SoRs are Salesforce, that approximately 21% of the set of SoRs are Citrite Concierge, and that approximately 9% of the set of SoRs are Broadcast. The histogram further indicates that approximately 6% of the set of SoRs are Workday and that approximately 24% of the set of SoRs are other SoRs.

Continuing with the integration control 306, the graph control 324 further displays a line graph of DAU values for microapps integrated with SoRs of the set of SoRs. The line graph indicates that the average DAU of microapps integrated with Salesforce is approximately 2, that the average DAU of microapps integrated with Citrite Concierge is approximately 7, and that the average DAU of microapps integrated with Broadcast is approximately 6. The line graph further indicates that the average DAU of microapps integrated with Workday is approximately 9 and that the average DAU of microapps integrated with other SoRs is approximately 11.

With regard to the persona control 308, each control within the statistical control set 326 is configured to display a summary statistic for a set of personas identified in the transactional data records falling within the target period. As shown in FIG. 3A, the statistical control set 326 includes a VALUES control configured to display a count of the transactional data records used to identify personas within the set of personas. The statistical control set 326 also includes a MISSING control configured to display a count of the transactional data records not used to identify personas within the set of personas. The statistical control set 326 further includes a DISTINCT control configured to display a number of unique personas identified within the set of personas. In the example illustrated in FIG. 3A, the VALUES control displays a value of 33, which is 100% of the transactional data records; the MISSING control displays a null value, which 0% of the transactional data records; and the DISTINCT control displays a value of 6, which is 18% of the set of personas.

Continuing with the persona control 308, the graph control 328 displays a histogram of the set of personas. In the example illustrated in FIG. 3A, this histogram indicates that approximately 42% of the set of personas are customer success personas, that approximately 33% of the set of personas are all employees personas, and that approximately 12% of the set of personas are managers personas. The histogram further indicates that approximately 6% of the set of personas are sales personas, and that approximately 6% of the personas are other personas.

Continuing with the persona control 308, the graph control 328 further displays a line graph of DAU values for microapps accessed via personas of the set of personas. The line graph indicates that the average DAU of microapps accessed via customer success personas is approximately 2, that the average DAU of microapps accessed via all employees personas is approximately 12, and that the average DAU of microapps accessed via managers personas is approximately 5. The line graph further indicates that the average DAU of microapps accessed via sales personas is approximately 10 and that the average DAU of microapps accessed via other personas is approximately 1.

Turning now to FIG. 3B, a buttons control 350 is illustrated. The buttons control 350 is a tab control and includes a MISSING control, a graph control 352, and a table control 354. Each of the controls included in the buttons control 350 is configured to display a summary information regarding a set of button groups identified in the transactional data from the target period. As shown in FIG. 3B, the MISSING control is configured to display a count of the transactional data records not used to identify button groups in the set of button groups. In the example illustrated in FIG. 3B, the MISSING control displays a null value, which is 0% of the transactional data records.

Continuing with the buttons control 350, the graph control 352 displays a histogram of the set of button groups. In the example illustrated in FIG. 3B, this histogram indicates that approximately 45% of the set of button groups included 1 button, that approximately 21% of the set of button groups included 0 buttons, and that approximately 9% of the set of button groups included 5 buttons. The histogram further indicates that approximately 9% of the set of button groups included 3 buttons, that approximately 9% of the set of button groups included 2 buttons, and that approximately 6% of the button groups included 4 buttons.

Continuing with the buttons control 350, the graph control 352 further displays a line graph of DAU values for microapps including button groups from the set of button groups. The line graph indicates that the average DAU of microapps having 1 button is 4.0, that the average DAU of microapps having 0 buttons is 5.9, and that the average DAU of microapps having 5 buttons is 4.9. The line graph further indicates that the average DAU of microapps having 3 buttons is 3.2, that the average DAU of microapps having 2 buttons is 14, and that the average DAU of microapps having 4 buttons is 13.6.

Continuing with the buttons control 350, the table control 354 displays a ranking of counts of button groups from the set of button groups. The table control 354 includes an identifier of each button group, a count for each button group that is equal to a number of times that the button group appears in the set of button groups, and a percentage of the cardinality of the set of button groups represented by each count. The table control 354 also includes an average DAU for microapps including the identified button group and an overall average DAU. In the example illustrated in FIG. 3A, microapps having 1 button have an average DAU of 4.0 and were interacted with by users 15 times during the target period, which represents 45% of the total number interactions. Microapps having 0 buttons have an average DAU of 5.9 and were interacted with by users 7 times during the target period, which represents 21% of the total number interactions. Microapps having 5 buttons have an average DAU of 4.9 and were interacted with by users 3 times during the target period, which represents 9% of the total number interactions. Microapps having 3 buttons have an average DAU of 3.2 and were interacted with by users 3 times during the target period, which represents 9% of the total number interactions. Microapps having 2 buttons have an average DAU of 14.0 and were interacted with by users 3 times during the target period, which represents 9% of the total number interactions. Microapps having 4 buttons have an average DAU of 13.6 and were interacted with by users 2 times during the target period, which represents 6% of the total number interactions. Overall microapps of all button groups have an average DAU of 5.9 and were interacted with by users 33 times during the target period.

Returning to FIG. 1, one or more client application(s) 106 are illustrated. In some examples, the client application(s) 106 can include one or more microapps or other software applications that host one or more microapps, such as a browser, a digital workspace application, or the like. In certain examples, a digital workspace application is a software program configured to deliver and manage a user's applications, data, and desktops in a consistent and secure manner, regardless of the user's device or location. The workspace application enhances the user experience by streamlining and automating those tasks that a user performs frequently, such as approving expense reports, confirming calendar appointments, submitting helpdesk tickets, and reviewing vacation requests. The workspace application allows users to access functionality provided by multiple enterprise applications—including “software as a service” (SaaS) applications, web applications, desktop applications, and proprietary applications—through a single interface. In some examples, the workspace application includes an embedded browser. The embedded browser can be implemented, for example, using the Chromium Embedded Framework.

In some examples, the client application(s) 106 participate in a virtual computing session with a remote server computer via a virtualization infrastructure. This virtualization infrastructure enables an application or operating system executing within a first physical computing environment (e.g., the server computer) to be accessed by a user of a second physical computing environment (e.g., an endpoint device hosting a client application 106) as if the application or operating system was executing within the second physical computing environment. Within the virtualization infrastructure, a server virtualization agent resident on the server computer is configured to make a computing environment in which it operates available to execute virtual (or remote) computing sessions. This server virtualization agent can be further configured to manage connections between these virtual computing sessions and other processes within the virtualization infrastructure, such as a client virtualization agent resident on the endpoint device. In a complementary fashion, the client virtualization agent is configured to connect (e.g., via interoperation with a broker) to the virtual computing sessions managed by the server virtualization agent. The client virtualization agent is also configured to interoperate with other processes executing within its computing environment (e.g., the client application 106) to provide those processes with access to the virtual computing sessions and the virtual resources therein. Within the context of a Citrix HDXTM virtualization infrastructure, the server virtualization agent can be implemented as, for example, a virtual delivery agent installed on a physical or virtual server or desktop and the client virtualization agent can be implemented as a service local to the endpoint device.

Continuing with the system 102, the monitoring service 112 is configured to track and monitor user activity conducted through the client application(s) 106. This activity can include any activity that the client application(s) 106 perform. As such, the activities tracked and monitored can include access to organizational resources, such as networks, devices, applications, and microapps. Users whose activity the monitoring service 112 is configured to track and monitor may include employees of an organization, subcontractors of the organization, or other users of the client application(s) 106. In some examples, the monitoring service 112 includes an enterprise analytics system, such as a CITRIX ANALYTICS service. Further, in certain examples, the monitoring service 112 is configured to expose and implement an API through which other processes (e.g., the engagement service 114) can request and receive information maintain by the monitoring service 112 (e.g., data stored in the behavior data store 124 and the preferences data store 126).

Within the system 102, the monitoring service 112 is configured to maintain the data stores 124 and 126. In some examples, the behavior data store 124 stores telemetry received as a result of, for example, horizontal product instrumentation, whereby each telemetry event conveys user and/or system information that is relevant to inferring user intentions. Examples of such telemetry events include type and volume of direct interactions between a user and a SoR, type and volume of indirect interactions between a user and a SoR (e.g., interactions via a microapp or some other intermediary, such as a client application 106), and type and volume of interactions involving personal responses to group cards. Additional examples of telemetry events include type and volume of interactions involving informational responses to actionable cards, type and volume of interactions with card source type (e.g., SoR-generated cards, re-shared posts, broadcasts, etc.), and interactions in which a user originates and owns a broadcast notification. Additional examples of telemetry events include a type of device (e.g., mobile or stationary) with which a user interacts, the time of day when an interaction occurs, the day of the week when an interaction occurs, and a cumulative session duration at which point an interaction occurs. Additional examples of telemetry events include discovered user's topics of interest, amount of time a user takes to respond to cards, a timestamp marking a user's last event within a microapp, and a number of days since a user's last event within a microapp. As illustrated by the examples listed above, the behavior data store 124 can store a vast array of telemetry events that document how a user interacts with the client application(s) 106 and how those interactions instigate interoperations between the client application(s) 106 and other computer-executable processes. These events can be used to identify user behavior patterns and, in some instances, intention and/or interests driving these patterns.

Continuing with the user monitoring service 112, in some examples the preferences data store 126 long-standing information descriptive of a user that is expressly configured by, or on behalf of, the user. Examples of data stored in the preferences data store 126 include static relevance rankings to be applied to cards by originating application (e.g., microapp, SoR, etc.) and card recipient type (personal, group, etc.); permanent or windowed muting preferences for cards by source type (e.g., mute re-shared cards from a specific user/group, etc.); and a list of application subscriptions. Other examples of data stored in the preferences data store 126 include role/function of the user, group/division/department/persona to which the user belongs, project/team participation, manager, branch location, date of employment, years of experience, and the like.

Returning to the system 102, in certain examples the engagement service 114 is configured to interoperate with the monitoring service 112 to derive one or more user engagement metric(s) and associated transactional information for an organization, such as the information described above with reference to FIGS. 2B-3B. In these examples, the engagement service 114 interoperates with the monitoring service via an API exposed and supported by the monitoring service 112. The engagement service can be configured to derive the engagement metric(s) and associated transactional information periodically or on demand. Depending on the capabilities and storage granularity implemented within the monitoring service 112, the engagement service 114 can derive some of the engagement metric(s) simply by requesting copies of the same from the monitoring service 112. However, in some instances, the engagement service 114 is configured to request and receive primitive attributes from the monitoring service and to aggregate these primitive attributes into aggregated attributes before using the aggregate attributes to derive user engagement metric(s), such as those described further below. In some examples, user engagement metric(s) are generated for specific types of applications (e.g., SaaS applications). Examples of the primitive attributes aggregated by the monitoring service 112 can include records of a variety of user interactions with the system, such as user logins, clicks, inputs, and logouts. The types of aggregation that the engagement service 114 is configured to perform can vary between examples, but some common types of aggregation that are based on descriptive statistics include max, min, mean, median, and standard deviation.

In certain examples, after deriving the user engagement metric(s), the engagement service 114 is configured to store the user engagement metric(s) in association with the transactional information and an identifier of the organization to which the user engagement metric(s) apply in the engagement data store 128. Further, in certain embodiments, the engagement service 114 is configured to expose and implement an API through which other processes (e.g., the microapp builder 104, the prediction service 110, etc.) can request the user engagement metric(s) and associated transactional information stored in the engagement data store 128. Examples of user engagement metric(s) that can be derived by the engagement service 114 and stored in the engagement data store 128 include daily average users (DAU), monthly active users (MAU), stickiness ratio (DAU/MAU), daily sessions per DAU, average session length, average session frequency, retention rate, and churn rate, to name a few. Further, in some examples, the engagement service 114 also stores data regarding the organization to which user engagement metric(s) apply in the engagement data store 128. Examples of such organizational data include an identifier of the organization, the organization's domain, size, location, and SaaS application usage.

Continuing with the system 102, in some examples the prediction service 110 is configured to identify a machine learning process that can accurately predict values of the user engagement metric(s) for microapps deployed within a subject organization based on design attributes received from the microapp builder 104 via the metadata store 108. In some situations, the identified machine learning process is a machine learning process trained by the prediction service 110 via interoperation with the engagement service 114. In other situations, where the subject organization has insufficient data available to train a machine learning process, the identified machine learning process is a machine learning process previously trained using data from another organization of sufficient similarity to the subject organization. This other organization may be, for example, a tenant of the same digital workspace cloud service as the subject organization. In this way, the system 102 can identify microapps that are good candidates for adoption by the user community within the subject organization.

In certain examples, the identified machine learning process is a regression process that approximates a function that maps the design attributes to values of the user engagement metrics. In these examples, the machine learning process is trained under supervision using labeled training data gathered from the engagement data store 128 via the engagement service 114.

Each of the data stores 108, 120, 124, 126, and 128 can be organized according to a variety of physical and logical structures. For instance, some of the data stores 108, 120, 124, 126, and 128 include data structures that store associations between identifiers of various system elements and workpieces. Within these data structures, the identifiers can be, for example, globally unique identifiers (GUIDs). Moreover, each of the data stores 108, 120, 124, 126, and 128 can be implemented, for example, as a relational database having a highly normalized schema and accessible via a structured query language (SQL) engine, such as ORACLE or SQL-SERVER. Alternatively or additionally, one or more of the data stores 108, 120, 124, 126, and 128 can include hierarchical databases, xml files, NoSQL databases, document-oriented databases, flat files maintained by an operating system and including serialized, proprietary data structures, and the like. Moreover, some or all of the data stores 108, 120, 124, 126, and 128 can be allocated in volatile memory to increase performance. Thus, each of the data stores 108, 120, 124, 126, and 128 as described herein is not limited to a particular implementation.

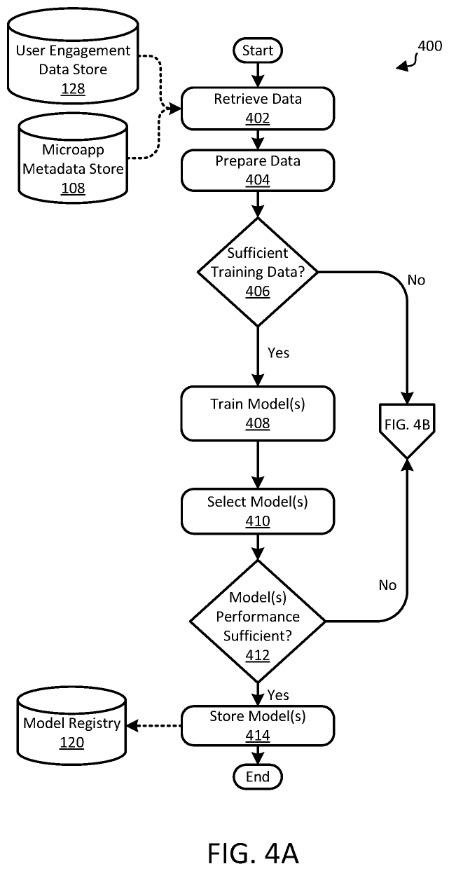

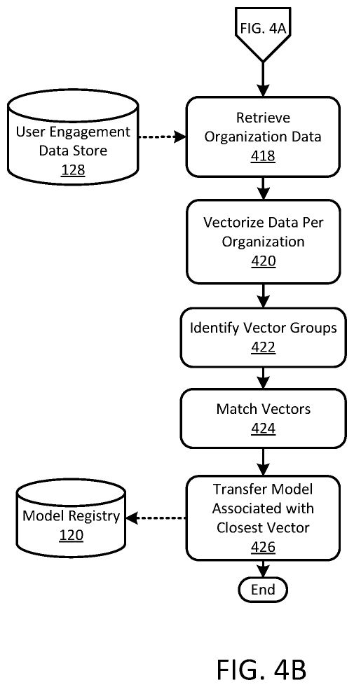

Turning now to FIGS. 4A and 4B, a training process 400 is illustrated that some examples of the training engine 116 are configured to execute to identify a trained machine learning model for a subject organization. As shown in FIG. 4A, the process 400 starts with a training engine (e.g., the training engine 116 of FIG. 1) retrieving 402 (e.g., via one or more API calls) data from a microapp metadata store (e.g., the metadata store 108 of FIG. 1) and data from an engagement data store (e.g., the engagement data store 128 of FIG. 1). The retrieved data can include design attributes of microapps in production within the subject organization and user engagement data regarding these production microapps.

Continuing with the process 400, the training engine prepares 404 the retrieved data. For instance, in some examples, the training engine combines and transforms the retrieved data to generate an original dataset with input variables (e.g., design attributes) and target variables (e.g., the user engagement metric(s)). Further, within the operation 404, the training engine splits the original dataset into a training dataset and a testing dataset. The training dataset can include, for example, 70% to 80% of the original dataset, with the testing dataset including the remainder.

Continuing with the process 400, the training engine determines 406 whether sufficient training data exists to properly train a machine learning process. For instance, in some examples, the training engine compares a number of samples included in the training data to a threshold value. In these examples, the training engine can identify the threshold value via empirical derivation using the “rule of 10” (e.g., the threshold value=10×the number of input variables), using the Vapnik-Chevronenkis dimension, or the like. Further, in these examples, the training engine determines 406 that the training data is sufficient where the number of samples exceeds the threshold. Further, in these examples, the training engine determines 406 that the training data is insufficient where the number of samples does not exceed the threshold. Where the training engine determines 406 that the training data is sufficient, the training engine proceeds to operation 408. Where the training engine determines 406 that the training data is insufficient, the training engine proceeds to operation 418 of FIG. 4B.

Continuing with the process 400, the training engine trains 408 one or more regression model(s) using the training data. Examples of the regression model(s) that can be trained in the operation 408 include a regression function, a convolutional neural network, and a random forest to name a few. In some examples, each of the regression model(s) are trained to predict a single user engagement metric (e.g. DAU). Alternatively or additionally, in some examples, a single regression model is trained to predict two or more user engagement metrics. In any case, a performance metric (e.g., R-Square, Adjusted R-Square, Mean Square Error (MSE), Root Mean Square Error (RMSE), Mean Absolute Error (MAE), Quadratic Loss, or L2 loss) is selected for training 408 each of the regression model(s). It should be noted that training 408 each of the regression model(s) includes tuning the hyper-parameters of each model.

Continuing with the process 400, the training engine selects 410 one or more model(s) from among the trained regression model(s) for potential subsequent use. For instance, in one example, the training engine executes each of the trained regression model(s) using the test dataset and calculates one or more performance metric(s) (e.g., MSE, RMSE, etc.) using the predictions generated by the trained regression model(s) and “ground truth” values of the target variables in the test dataset. In these examples, the training engine selects 410 the model(s) with performance metric(s) that meet or surpass one or more criteria. For instance, the training engine may select a model with the lowest RMSE. In some examples, the training engine selects 410 the model(s) based on a combination of criteria including performance, robustness (performance across various performance metrics), consistency (similarity of behavior across datasets), and whether or not the model(s) predict the user engagement metric(s) with sufficient certainty. For instance, the training engine may select a model with the lowest RMSE that also has an MAE<5. It should be noted that the example criteria described above are provided by way of example only and that other criteria may be used in various examples.

Continuing with the process 400, the training engine determines 412 whether at least one of the trained regression model(s) was selected 410. If so, the training engine proceeds to operation 414. Otherwise, the training engine proceeds to operation 418 of FIG. 4B.

Continuing with the process 400, the training engine stores 414 the selected model(s) in a model registry (e.g., the model registry 120 of FIG. 1). In some examples, the training engine stores 414 the selected model(s) in one or more format(s) that can easily deploy to a machine learning service (e.g., the machine learning service 122 of FIG. 1) via, for example, a REST API or batch interface supported by the machine learning service. Upon completion of the operation 414, the process 400 ends. It should be noted that, in some examples, each of the selected model(s) is stored in association with an identifier of the organization whose data was used to train the selected model(s).

Continuing with the process 400 with reference to FIG. 4B, the training engine retrieves 418 organizational data for all organizations identified in the engagement data store. For instance, in some examples, for each identified organization the training engine retrieves an identifier of the organization and the organization's domain, size, location, SaaS application usage, and user engagement metric(s).

Continuing with the process 400, the training engine vectorizes 420 the domain, size, location, SaaS application usage for each organization and associates the resulting vector with an identifier of the organization. For instance, in some examples, the training engine executes a vectorization technique such as quantization, one-hot encoding, or embeddings to vectorize 420 the domain, size, location, and SaaS application usage for each organization.

Continuing with the process 400, the training engine identifies 422, from the vectors generated in operation 420, a first group of vectors associated with organizations that have historic microapp usage that is below a threshold and a second group of vectors associated with organizations that have historic microapp usage that is equal to or above the threshold. For instance, in some examples, the training engine identifies 422 a vector as being of the first group where the organization associated with the vector has less than a threshold number of microapps in production. In these examples, the training engine identifies 422 a vector as being of the second group where the organization associated with the vector has a number of microapps in production that is equal to or greater than the threshold. It should be noted that the subject organization may be associated with a vector of the first group.

Continuing with the process 400, the training engine matches 424 each vector from the first group to a vector from the second group that is closest to the vector from the first group. For instance, in some examples, the training engine uses a distance metric such as Euclidean distance, Manhattan distance, or Mahalanobis distance to determine distance between vectors within the operation 424. Alternatively or additionally, in some examples, the training engine uses cluster analysis to match 424 each vector from the first group to a vector of the second group. In these examples, the training engine identifies clusters within the second group at multiple levels of granularity (e.g., by using means-shift clustering with multiple window/radius sizes), identifies centroids within these clusters, and matches each vector from the first group to its closest centroid. Example methods that the training engine can execute to find clusters within the operation 424 include the elbow method and the silhouette method, to name a few.

Continuing with the process 400, the training engine identifies the selected model(s) of each organization associated with a vector from the second group matched to a vector from the first group and transfers 426 a copy of the selected model(s) to the organization associated with the vector from the first group matched to the vector from the second group. For instance, in some examples, the training engine transfers a copy of the selected models(s) by storing an association in the model registry between the selected model(s) and an identifier of the organization associated with the vector from the first group matched to the vector from the second group. In this way, the process 400 may identify a trained machine learning model for the subject organization that is trained using data from another organization. Upon completion of the operation 426, the process 400 ends.

It should be noted that the process 400 can be repeated periodically or on-demand. As such, organizations associated with vectors from the first group in early iterations of the process 400 may come to be associated with vectors from the second group in subsequent iterations. In this way, models transferred via operation 426 may act as a temporary bridge for organizations in their early phases of microapp adoption.

Returning to FIG. 1, some examples of the system 102 are configured to execute one or more prediction processes that involve the microapp builder 104 and the prediction service 110. Within the prediction service, the prediction engine 118 is configured to handle prediction requests (e.g., received form the microapp builder 104) by interoperating with the machine learning service 122 as will be described further below. The machine learning service 122 is configured to receive, deploy, and execute machine learning models under the direction of the prediction engine 118. In some examples, the machine learning service 122 is implemented using a commercially available machine learning service such as MICROSOFT AZURE Machine Learning.

FIG. 5 illustrates one example of a prediction process 500 that some examples of the system 102 are configured to execute. As shown in FIG. 5, the process 500 starts with a microapp builder (e.g., the microapp builder 104 of FIG. 1) receiving 502 design attributes of a microapp. For instance, in one example, the microapp builder receives the design attributes via a screen (e.g., the screen 200 of FIG. 2A). In addition, within the operation 502, the microapp builder may receive input from a user requesting prediction of a value of a user engagement metric based on the design attributes. For instance, in one example, the microapp builder receives input selecting a predict control (e.g., the predict control 242 of FIG. 2).

Continuing with the process 500, the microapp builder generates a prediction request and transmits 504 the prediction request to a prediction service (e.g., the prediction service 110 of FIG. 1). The prediction request specifies (by copy or by reference) the design attributes received in the operation 502.

Continuing with the process 500, the prediction service receives 506 the prediction request and passes the prediction request to a prediction engine (e.g., the prediction engine 118 of FIG. 1) for handling. The prediction engine parses the prediction request to extract an identifier of the user's organization and identifies 508 a model associated with the extracted organizational identifier within a model registry (e.g., the model registry 120 of FIG. 1). The prediction engine next deploys 510 the identified model to a machine learning service (e.g., the machine learning service 112 of FIG. 1). The machine learning service receives 512 the model and readies the model for use.

Continuing with the process 500, the prediction engine initiates 514 the model using the design attributes specified in the prediction request. The machine learning service executes 516 the model and transmits 518 a result (e.g., one or more predicted value(s) of the user engagement metric(s)) to the prediction engine.

Continuing with the process 500, the prediction engine receives 520 the result from the machine learning service and passes the result to the prediction service. The prediction service receives the result and generates 522 a response to the prediction request. This prediction response includes the received result. The prediction service transmits 524 the prediction response to the microapp builder.

Continuing with the process 500, the microapp builder receives 526 the prediction response, parses the response to extract the predicted value(s), and displays 528 the predicted value(s), for example, in a screen (e.g., the screen 200 of FIG. 2B). Upon completion of the operation 528, the process 500 ends.

The processes as disclosed herein each depict one particular sequence of operations in a particular example. Some operations are optional and, as such, can be omitted in accord with one or more examples. Additionally, the order of operations can be altered, or other operations can be added, without departing from the scope of the apparatus and methods described herein.

### Computing Device for Engagement Prediction Systems

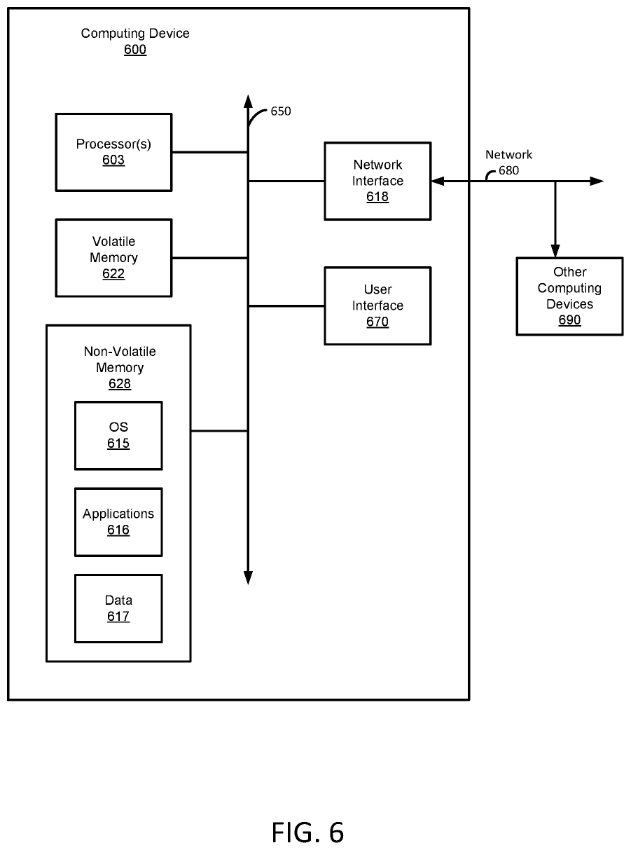

FIG. 6 is a block diagram of a computing device 600 configured to implement various user engagement prediction systems and processes in accordance with examples disclosed herein.

The computing device 600 includes one or more processor(s) 603, volatile memory 622 (e.g., random access memory (RAM)), non-volatile memory 628, a user interface (UI) 670, one or more network or communication interfaces 618, and a communications bus 650. The computing device 600 may also be referred to as a client device, computing device, endpoint, computer, or computer system.

The non-volatile (non-transitory) memory 628 can include: one or more hard disk drives (HDDs) or other magnetic or optical storage media; one or more solid state drives (SSDs), such as a flash drive or other solid-state storage media; one or more hybrid magnetic and solid-state drives; or one or more virtual storage volumes, such as a cloud storage, or a combination of such physical storage volumes and virtual storage volumes or arrays thereof.

The user interface 670 can include a graphical user interface (GUI) (e.g., controls presented on a touchscreen, a display, etc.) and one or more input/output (I/O) devices (e.g., a mouse, a keyboard, a microphone, one or more speakers, one or more cameras, one or more biometric scanners, one or more environmental sensors, one or more accelerometers, one or more visors, etc.).

The non-volatile memory 628 stores an operating system 615, one or more applications or programs 616, and data 617. The operating system 615 and the application 616 include sequences of instructions that are encoded for execution by processor(s) 603. Execution of these instructions results in manipulated data. Prior to their execution, the instructions can be copied to the volatile memory 622. In some examples, the volatile memory 622 can include one or more types of RAM or a cache memory that can offer a faster response time than a main memory. Data can be entered through the user interface 670 or received from the other I/O device(s), such as the network interface 618. The various elements of the device 600 described above can communicate with one another via the communications bus 650.

The illustrated computing device 600 is shown merely as an example client device or server and can be implemented within any computing or processing environment with any type of physical or virtual machine or set of physical and virtual machines that can have suitable hardware or software capable of operating as described herein.

The processor(s) 603 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor(s) 603 can be analog, digital or mixed. In some examples, the processor(s) 603 can be one or more local physical processors or one or more remotely located physical processors. A processor including multiple processor cores or multiple processors can provide functionality for parallel, simultaneous execution of instructions or for parallel, simultaneous execution of one instruction on more than one piece of data.

The network interfaces 618 can include one or more interfaces to enable the computing device 600 to access a computer network 680 such as a Local Area Network (LAN), a Wide Area Network (WAN), a Personal Area Network (PAN), or the Internet through a variety of wired or wireless connections, including cellular connections and Bluetooth connections. In some examples, the network 680 may allow for communication with other computing devices 690, to enable distributed computing.

In described examples, the computing device 600 can execute an application on behalf of a user of a client device. For example, the computing device 600 can execute one or more virtual machines managed by a hypervisor. Each virtual machine can provide an execution session within which applications execute on behalf of a user or a client device, such as a hosted desktop session. The computing device 600 can also execute a terminal services session to provide a hosted desktop environment. The computing device 600 can provide access to a host computing environment including one or more applications, one or more desktop applications, and one or more desktop sessions in which one or more applications can execute.

### Example Engagement Prediction System

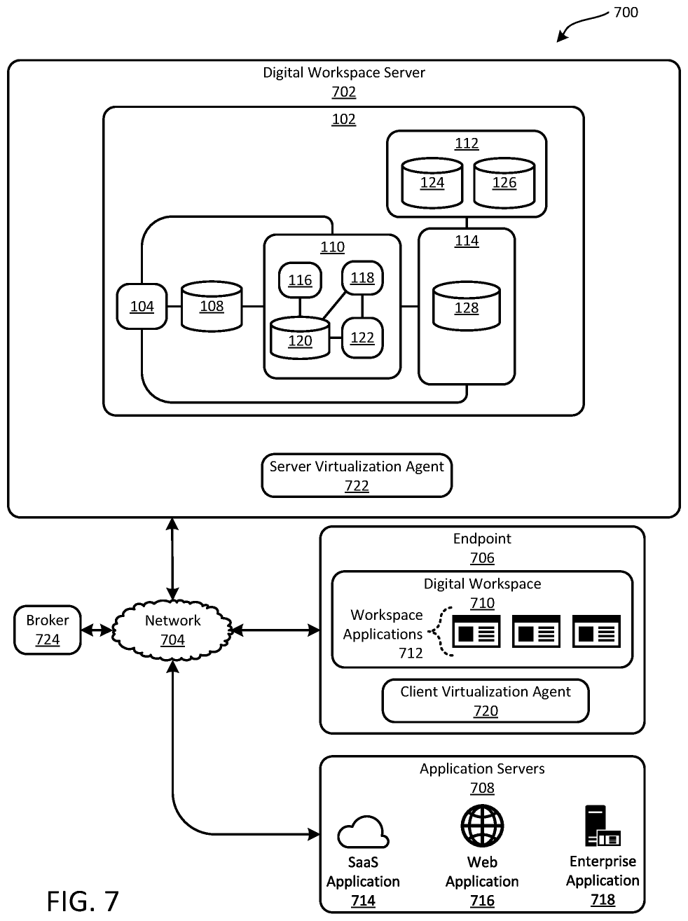

FIG. 7 is a block diagram schematically illustrating selected components of an example implementation of a user engagement prediction system 700 that generates predicted values for user engagement metric(s) based on microapp design attributes. The system 700 includes a digital workspace server 702 that is capable of analyzing how a user, associated with an endpoint 706, interacts with applications provided by one or more application servers 708. The user's association with the endpoint 706 may exist by virtue of, for example, the user being logged into or authenticated to the endpoint 706. While only one endpoint 706 and three example application servers 708 are illustrated in FIG. 7 for clarity, it will be appreciated that, in general, system 700 is capable of analyzing interactions between an arbitrary number of endpoints and an arbitrary number of application servers. Digital workspace server 702, endpoint 706, and application servers 708 communicate with each other via a network 704. The network 704 may be a public network (such as the Internet) or a private network (such as a corporate intranet or other network with restricted access). Other embodiments may have fewer or more communication paths, networks, subcomponents, and/or resources depending on the granularity of a particular implementation. For example, in some implementations at least a portion of the application functionality is provided by one or more applications hosted locally at an endpoint. Thus references to application servers 708 should be understood as encompassing applications that are locally hosted at one or more endpoints. It should therefore be appreciated that the embodiments described and illustrated herein are not intended to be limited to the provision or exclusion of any particular services and/or resources.

Digital workspace server 702 is configured to host the system 102 and server virtualization agent 722. The digital workspace server 702 may comprise one or more of a variety of suitable computing devices, such a desktop computer, a laptop computer, a workstation, an enterprise-class server computer, a tablet computer, or any other device capable of supporting the functionalities disclosed herein. A combination of different devices may be used in certain embodiments. As illustrated in FIG. 7, digital workspace server 702 includes one or more software programs configured to implement certain of the functionalities disclosed herein as well as hardware capable of enabling such implementation.

As noted above, in certain embodiments endpoint 706 is embodied in a computing device that is used by the user. Examples of such a computing device include but are not limited to, a desktop computer, a laptop computer, a tablet computer, and a smartphone. Digital workspace server 702 and its components are configured to interact with a plurality of endpoints. In an example embodiment, the user interacts with a plurality of workspace applications 712 that are accessible through a digital workspace 710, which serves as one of the client application(s) 106 discussed above with reference to FIG. 1. The user's interactions with workspace applications 712 and/or application servers 708 are tracked, monitored, and analyzed by the system 102, as described above. Any microapps can be made available to the user through digital workspace 710, thereby allowing the user to view information and perform actions without launching (or switching context to) the underlying workspace applications 712. Workspace applications 712 can be provided by application servers 708 and/or can be provided locally at endpoint 706. For instance, example workspace applications 712 include a SaaS application 714, a web application 716, and an enterprise application 718, although any other suitable exiting or subsequently developed applications can be used as well, including proprietary applications and desktop applications. To enable the endpoint 706 to participate in a virtualization infrastructure facilitated by the broker computer 724 and involving the server virtualization agent 722 as discussed herein, the endpoint 706 also hosts the client virtualization agent 720.

The broker computer 724 is configured to act as an intermediary between the client virtualization agent 720 and the server virtualization agent 722 within the virtualization infrastructure. In some examples, the broker computer 724 registers virtual resources offered by server virtualization agents, such as the server virtualization agent 722. In these examples, the broker computer 724 is also configured to receive requests for virtual resources from client virtualization agents, such as the client virtualization agent 720, and to establish virtual computing sessions involving the client virtualization agent 720 and the server virtualization agent 722.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A computer system comprising:
a memory;
a network interface; and
at least one processor coupled to the memory and the network interface and configured to
receive, via the network interface, one or more design attributes of a microapp from a microapp development tool hosted by an endpoint device, the one or more design attributes comprising an identifier of a system of record configured to supply data to the microapp,
execute a machine learning process trained, using data regarding microapp usage within an organization, to predict at least one user engagement metric for the microapp based on the one or more design attributes, and
transmit, via the network interface, the at least one user engagement metric to the microapp development tool hosted by the endpoint device.

2. The computer system of claim 1, wherein the at least one processor is further configured to identify the machine learning process from a plurality of machine learning processes.

3. The computer system of claim 2, wherein the plurality of machine learning processes comprises a first machine learning process trained using data regarding microapp usage within the organization and a second machine learning process trained using data regarding microapp usage within the organization.

4. The computer system of claim 2, wherein the organization is a first organization and the plurality of machine learning processes comprises a first machine learning process trained using data regarding microapp usage within the first organization and a second machine learning process trained using data regarding microapp usage within a second organization distinct from the first organization.

5. The computer system of claim 4, wherein the microapp is designed for use within the second organization.

6. The computer system of claim 5, wherein to identify the machine learning process comprises to match the second organization with the first organization.

7. The computer system of claim 6, wherein to match comprises to calculate a distance between vector representations of the second organization and the first organization.

8. The computer system of claim 4, wherein the machine learning process is a first machine learning process and the at least one processor is further configured to
train a second machine learning process using data regarding microapp usage in the second organization; and
execute the second machine learning process to predict one or more user engagement metrics for the microapp based on the one or more design attributes.

9. A method of predicting user engagement metrics based on a microapp design, the method comprising:
receiving, via a network interface, one or more design attributes of a microapp from a microapp development tool hosted by an endpoint device, the one or more design attributes comprising an identifier of a system of record configured to supply data to the microapp;
executing a machine learning process trained, using data regarding microapp usage within an organization, to predict at least one user engagement metric for the microapp based on the one or more design attributes; and
transmitting, via the network interface, the at least one user engagement metric to the microapp development tool hosted by the endpoint device.

10. The method of claim 9, further comprising identifying the machine learning process from a plurality of machine learning processes.

11. The method of claim 10, wherein identifying the machine learning process from a plurality of machine learning processes comprises identifying the machine learning process from a first machine learning process trained using data regarding microapp usage within the organization and a second machine learning process trained using data regarding microapp usage within the organization.

12. The method of claim 10, wherein the organization is a first organization and identifying the machine learning process from a plurality of machine learning processes comprises identifying the machine learning process from a first machine learning process trained using data regarding microapp usage within the first organization and a second machine learning process trained using data regarding microapp usage within a second organization distinct from the first organization.

13. The method of claim 12, wherein receiving the one or more design attributes of the microapp comprises receiving one or more design attributes of a microapp designed for use within the second organization.

14. The method of claim 13, wherein identifying the machine learning process comprises matching the second organization with the first organization.

15. The method of claim 14, wherein matching comprises calculating a distance between vector representations of the second organization and the first organization.

16. The method of claim 12, wherein the machine learning process is a first machine learning process, the method further comprising
training a second machine learning process using data regarding microapp usage in the second organization; and
executing the second machine learning process to predict one or more user engagement metrics for the microapp based on the one or more design attributes.

17. A non-transitory computer readable medium storing processor executable instructions to predict user engagement metrics based on a microapp design, the instructions comprising instructions to:
receive, via a network interface, one or more design attributes of a microapp from a microapp development tool hosted by an endpoint device, the one or more design attributes comprising an identifier of a system of record configured to supply data to the microapp;
execute a machine learning process trained, using data regarding microapp usage within an organization, to predict at least one user engagement metric for the microapp based on the one or more design attributes; and
transmit, via the network interface, the at least one user engagement metric to the microapp development tool hosted by the endpoint device.

18. The non-transitory computer readable medium of claim 17, wherein the instructions further comprise instructions to identify the machine learning process from a plurality of machine learning processes.

19. The non-transitory computer readable medium of claim 18, wherein the organization is a first organization and the instructions to identify the machine learning process comprise instructions to match a second organization with the first organization.

20. The non-transitory computer readable medium of claim 19, wherein the machine learning process is a first machine learning process and the instructions further comprise instructions to:
train a second machine learning process using data regarding microapp usage in the second organization; and
execute the second machine learning process to predict one or more user engagement metrics for the microapp based on the one or more design attributes.
